(19) United States
(12) Patent Application Publication
(10) Pub. No.: US 2008/0134794 A1
(43) Pub. Date: Jun. 12, 2008

(54) Dosimeter For Body Vibrations

(76) Inventor: Peter Jonsson, Lulea (SE)

Correspondence Address: YOUNG & THOMPSON, 209 Madison Street, Suite 500, ALEXANDRIA, VA, 22314, US

(21) Appl. No.: 11/795,952

(22) PCT Filed: Jan. 25, 2006
(86) PCT No.: PCT/SE06/00099

§ 371 Date: Jul. 25, 2007

(30) Foreign Application Priority Data
Jan. 26, 2005 (SE) 0500191-2

(51) Int. Cl. G01H 1/00

(52) U.S. Cl. 73/660

(57) ABSTRACT

The invention relates to a dosimeter for vibration measurements for a driver of a vehicle. The dosimeter is adapted to be attached to at a superficial skeleton part of the body of a driver, for the best possible vibration measurements. The dosimeter measures and stores the body vibrations, measured on the body, during the working day of the driver. A driver can immediately observe if a limit value or an input value is exceeded.

### TECHNICAL FIELD

The invention concerns devices and methods for vibration measurement. The invention concerns more precisely such devices and methods aiming to identify if a limit value is exceeded or not exceeded, where the limit value is related to vibrations a person is exposed to. The alternative term for the limit value, used in this context is input value.

### PRIOR ART

Workers within certain professions are exposed to vibrations transmitted to one's body. This causes body vibrations. Workers within certain professions are exposed to vibrations that affect such a great part of one's body that they have a character of whole-body vibrations. Examples of such professions are truck-drivers, tractor drivers, forest machine drivers, reaping-machine drivers, scarification machine drivers, drilling-machine operators and piling machine operators.

Other persons exposed to body vibrations are scooter-drivers and boat drivers who usually drive standing. In order to carry out the health risks assessments for a person working in a certain type of vehicle, it is usually used a method which collects the measurements of the vibrations between the seated person and the seating area, created in simulated working conditions during a limited period of time. Such method is described by the standard ISO 2631-1. The problem with such method is that those simulated working conditions seldom correspond to the real working conditions. Another problem is that the vibrations are measured only during a limited period of time. The further problem is that the daily work is stopped during the measuring period. The disadvantage of the existing technique is that it does not give the possibilities for an individual to adjust the way that a person performs his/her work based on the measurements taken from the person's, such as driver's, typical working situation.

One example of a dosimeter that is applied in the method above is described in the U.S. Pat. No. 6,490,929. There is a means identifying which structures or equipment the vibrations originate. The dosimeter determines if a vibration arises and how long the vibration lasts. The dosimeter neither measures nor stores the amount of the actual vibrations. The expected level of vibrations is known for a given type of equipment, which is considered to be used by the driver. This is due to the fact that the expected vibration levels were measured up in advance while the system was being designed and stored in a supervising unit.

JP 3,185,317 describes a system in order to handle large quantity of data taken from vibration measurements. Every operator involved in an operation with vibrations in a facility carries a personal vibration measurer during the operation, and a vibration detecting signal from a vibration detector sensor is at that time written as data, about how large amount of vibrations have been noticed by a sensor.

DE 10119525 shows a device which consists of a measurement device and a measurement transducer for hand-arm vibrations. A worker wears the measurement transducers and measurement device on the body for both measurement tasks in such a way that neither the ability to work nor the measurement process is hindered. The device measures vibrations from a hand-held tool, such as drill. One of several remaining problems is that device is not adapted for whole body vibration measurement, for instance the device has features which makes it suitable to be held in the hand of the worker while operating the hand-held tool.

### OBJECT AND SUMMARY OF THE INVENTION

The object of the invention is to assign a dosimeter for whole body vibration measurements intended to be carried by a driver of a vehicle, which measures vibrations on the driver's body with high reliability.

The object of the dosimeter above is achieved, characterized in that the dosimeter comprises elements to be attached to a superficial skeleton part, possible to sense through the skin of a driver of a vehicle, that the dosimeter comprises memory means in order to store, in a digital form, a multitude of vibration data from a number of measurement occasions and that the dosimeter comprises a presentation means where the vibration measurement results are presented. Further characteristics are shown in the attached patent claims.

An advantage with the present invention is that while vibration measurement takes place there is no need for the daily work to stop. This is compared to the traditional measuring devices and measuring methods where a reference measurement performed on a chair or a seat is based on simulated working conditions.

An advantage with the innovation is that it provides an advanced ground for making a conclusion if a limit value is exceeded, because it allows measuring even when the driver is not seated during the whole working process, for example while conveying a boat or scooter.

The vibration dosimeter is adapted to minimize loss in vibration transferred between the drives body and the dosimeter. A vibration dosimeter does typically not have any flexible layer attached as part of the coating of the attachment area. In some cases the dosimeter may comprise a flexible layer and in such a case a transfer function relating to the flexible layer should be used in calculation of the dosimeter.

A further advantage is that the invention allows that the final conclusion if the limit value is exceeded is based on the measurement of the amount of whole body vibration exposure, and the real exposure time during the performed work along with the personal transports. This is in contrast to the existing measuring methods and measuring devices where the final decision is often based upon the operating time of the vehicle, as well as the nominal vibration level measured under simulated working conditions.

The further advantage is that the driver who is directly involved with the conveying of the vehicle can read the vibration measurement results, which allows the driver himself/herself to make a connection between the body vibrations, driving on alternative routes or adapting the velocity of the vehicle. This invention can help the driver to make decisions that reduce the body vibrations that he/she is exposed to during those working stages. Employers that equip their drivers with the dosimeter are enabled to perform the vibration measurements daily, without engaging an external consultant who performs or interprets the vibration measurements. According to the invention, a dosimeter can be also used for performing vibration measurements using conventional methods, e.g. by measuring vibrations on a driver's seat.

A further aim of the invention is to provide a system, which enables a driver of a vehicle to adjust his/hers driving behavior according to vibration measurements. The aim is achieved by a system comprising a dosimeter for whole body vibration measurement and a vibration indicator attached at a position in the vehicle in front of the driver. The system is characterized in that the display comprises means for presentation of the level of a recent vibration measurement and a level of accumulated vibration dose.

### FIGURE DESCRIPTION

The invention is more precisely explained under reference to the attached figures, where

FIG. 1a shows an example of a dosimeter according to the invention.

FIG. 1b shows a schematic cutaway view of a dosimeter.

FIG. 2a shows an overview of a dosimeter placed against a superficial skeleton part, such as the spine, on a driver, with the help of a belt or a strap.

FIG. 2b shows an overview of a dosimeter placed against the hipbone of a driver.

FIG. 2c shows an overview of a dosimeter placed against the skull of a driver.

FIG. 3 shows an appropriate measuring point according to the invention, placed against the spine of a driver.

FIG. 4 shows a measuring point for a vibration measurements according to the previously known measuring devices and methods, which is on, by or under the seat. The dosimeter according to the invention can be also for ordinary measurements.

FIG. 5 shows a measuring of vibration measurements of vibrations transmitted via a floor.

FIG. 6 shows an embodiment form of a dosimeter which comprises an option formed as a measurement plate. The measurement plate is intended to be used while performing vibration measurements inside structures.

FIG. 7 shows an example of a vehicle whose driver does not typically sit during the whole working stage. The vehicle in this example is a scooter or snowmobile.

FIG. 8 shows an overview of a system comprising a vibration dosimeter for whole body measurement, the dosimeter attached to the driver of a vehicle, and a vibration indicator positioned in front of the driver.

### DETAILED DESCRIPTION OF THE INVENTION

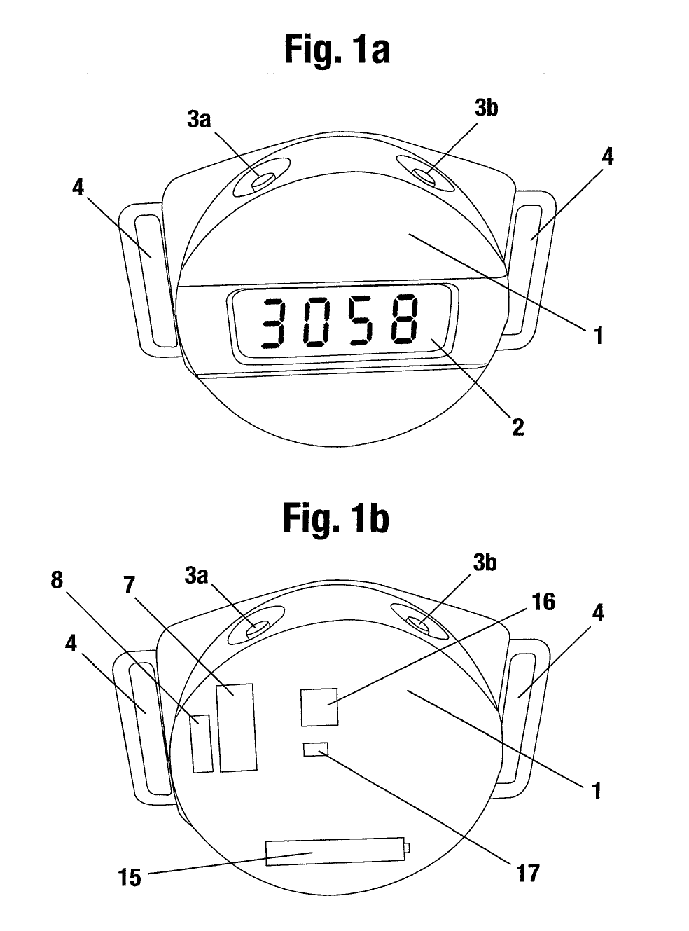

FIG. 1a shows an example of a dosimeter 1 according to the invention. The dosimeter 1 is mainly flat and of typical thickness of only 6-21 mm. Typical sizes of the dosimeter, width or diagonally are 30-60 mm. The dosimeter 1 comprises a push devices 3a-3b, such as press or push-buttons, to turn on and off the dosimeter 1 The dosimeter 1 also comprises a means to store energy, e.g. a battery 15 which has an advantage of being rechargeable. The dosimeter 1 may comprise more than one battery. As an alternative to the battery 15 a super condenser may be used. The dosimeter 1 also comprises a presentation means 2, which for example is a display or a small screen, which is also shown in FIG. 1a. The push devices 3a-3b that the dosimeter 1 comprises are advantageously implanted such that one push device 3a corresponds the functions of turning on the dosimeter 1 and activating of vibration measurements with the r.m.s. (root mean square) method. An example of a further measuring method which is advantageously activated by means of a press/push device is VDV (vibration dose value), MTVV (max transient vibration value) and peak. In one embodiment the previously mentioned press or push element 3a toggles between r.m.s., VDV, MTVV and peak when pressed down. In this embodiment the actual measuring method is shown in textual form on the display element 2.

FIG. 1b shows a schematic cutaway view of a dosimeter 1. The figure implies some of the components that a dosimeter 1 comprises. The components can be integrated in one or more integrated circuit. It is also possible that the components are embedded in a polymer or varnished.

A dosimeter 1 according to the invention comprises a counting means 7 to count the r.m.s. value for every measuring occasion. The counting means 7 input data is based on measurements from the vibration emitting element 16, according to which the r.m.s value forms the already mentioned vibration data related to every single measuring occasion. The invention makes it possible to supervise a possible exceeding of a limit value based on real body vibrations. This is compared with the known technique that is e.g. based on reference vibration measurements on a seat under simulated working conditions and working time. Or else another known technique which e.g. is based on a person carrying with him/her a measuring device which detects the occurrence of vibrations without any data being stored. The counting means 7 in the dosimeter can be e.g. a microprocessor or a signal processor. The dosimeter 1 is typically also enabled to calculate according to MTVV- and VDV- methods.

The dosimeter 1 comprises a memory means 8 in order to store the measurement data. Memory means 8 can be built-in or integrated with the measuring means 7. It is also considered as an advantage if a measuring means 8 in the dosimeter 1 stores a peak value.

In this embodiment form, the dosimeter according to the invention comprises a means of calculating r.m.s. defined according to the equation (1) as shown below:

$${a}_{w} = {[ \frac{1}{T} {\int }_{0}^{T} {a}_{w}^{2} ( t ) d t ]}^{\frac{1}{2}} ( {ms}^{- 2} ) \qquad ( 1 )$$

where T is the measuring time and a_{w} is weighted frequency acceleration.

It is an advantage if a dosimeter 1 comprises means for counting MTVV defined according to the equation (2) as below:

MTVV, equation (2), is the highest level of a_{w}, (t₀) (index w stands for weighted data):

MTVV=max [α_{w}(t)] (ms⁻²) (2)

where a_{w}(t₀) is defined according to the equation (3):

$${a}_{w} ( {t}_{o} ) = {\{ \frac{1}{τ} {\int }_{{t}_{0} - τ}^{{t}_{o}} {[ {a}_{w} ( t ) ]}^{2} d t \}}^{\frac{1}{2}} ( {ms}^{- 2} ) \qquad ( 3 )$$

t₀ is the instantaneous time, a_{w} (t₀) is instantaneously weighted frequency acceleration calculated with the help of “running r.m.s” method of assessment, integration time (τ) makes an advantage of 1 second.

In this embodiment form the dosimeter 1 comprises a means of calculating VDV defined according to the equation (4) as shown below. VDV, equation (4), is based on the fourth exponent or index of acceleration:

$$VDV = {\{ {\int }_{0}^{T} {[ {a}_{w} ( t ) ]}^{4} d t \}}^{\frac{1}{4}} ( {ms}^{- 1.75} ) \qquad ( 4 )$$

where T is the measuring time and aw is weighted frequency acceleration.

The vibrations are frequency weighted by the dosimeter. An appropriate weighing filter is ‘W_{d}’ which is used for vibrations in the x-axel and the y-axel. ‘Wₖ’ is used for z-axel vibrations, which are measured e.g. on a seating surface. ‘W_{c} ’ and ‘W_{d}’ is advantageously used for vibrations in the x-axel and the y-axel measured on the seat back or on the driver's spine. The weighing filter ‘Wₑ’ is applied to the rotational data in the driver's/seating area. The ISO 2631-1 standard describes the appropriate embodiment forms of this weighing filter.

Vibration emitting element is a 3-axes accelerometer. The 3-axes accelerometer can be of analogous type. In that case the dosimeter comprises at least one A/D-transducer. The A/D-transducer can be integrated in a circuit with a multitude of other components or mounted as a separate component on a printed circuit card. The 3-axes accelerometer emits a typical measurand value such as m/sek² or m/sek. Those measurand values are converted inside the dosimeter, e.g. with the help of the calculation means 7, to the units related to frequencies. It is an advantage to choose a 3-axes accelerometer which has a high quality range of measurement in the frequency range between 0.5-80 Hz. The r.m.s. values that are calculated by the calculation means 7 comprise frequencies mostly in the area between 0.5-80 Hz.

This is an advantage if the off-function of a dosimeter 1 activates via a press or push element 3b, as a push button, separated from the press or push element 3a, which corresponds to the on-function. The off-function can be implemented in such a way that it is necessary to hold the press or push element 3b pressed down for a certain number of seconds in order to switch off the dosimeter 1. Resetting of the dosimeter 1 may be implemented such that it can be activated for example by pressing down simultaneously the mentioned press or push elements 3a-3b.

After repeated calculations and attempts the inventor came to the conclusion that there is a distinctive advantage to place the dosimeter 1 against a part of the body where the skeleton is sensed through the skin. The dosimeter 1 is commonly adapted to be attached to the back-bone or hip-bone, this in order to ensure an efficient transfer of whole body vibrations to the dosimeter. It may also be suitable to attach the dosimeter to the skull bone. The dosimeter 1 comprises elements 4 that enable contact opportunities. In the figure la there is a number of those contact opportunity enabling elements 4 shaped as attachment 4 for a strap or a belt 6. The contact opportunity enabling element 4 is aimed to get the dosimeter 1 placed at a superficial skeleton part of the driver's body 5. The belt or a strap 6 that is extended to the attachment 4 may be attached to, in its turn to another strap or belt, such as body belt. In one embodiment underside of the dosimeter is rounded in order to be in close contact with the spine/back, the hipbone or the skullbone.

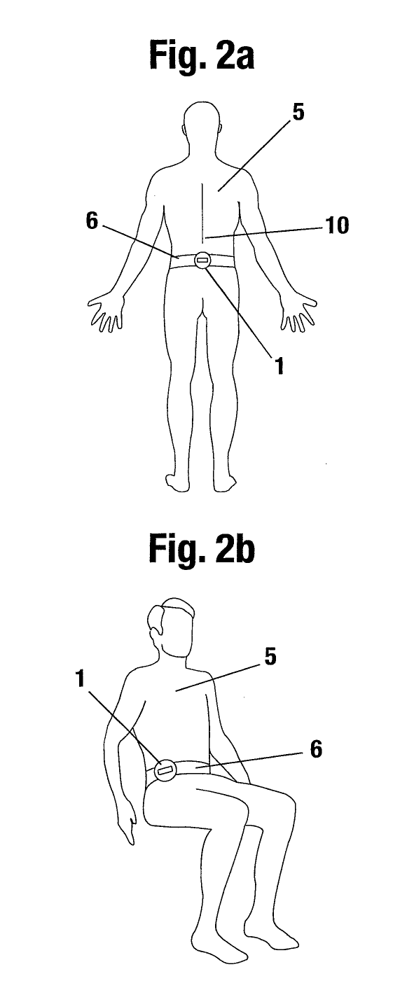

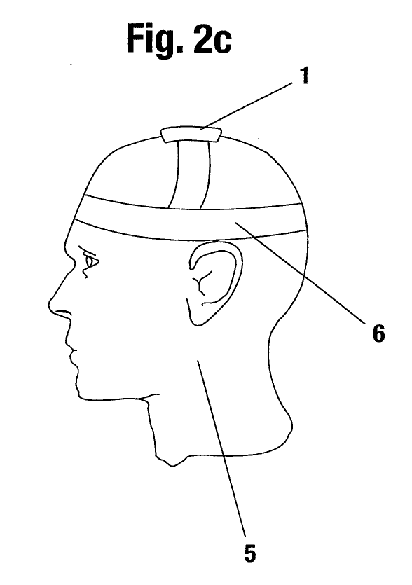

FIG. 2a shows an example of a driver 5 with a belt 6. In this case the dosimeter 1 comprises two attachments 4 for the belt. FIG. 2a indicates that the dosimeter 1 is in close contact with the driver's 5 spine or back. In another embodiment the dosimeter 1 additionally comprises at least an attachment 4 for a belt construction which is intended to be placed over the driver's shoulders for an improved body contact with the dosimeter 1. Dosimeter 1 can also be in close contact with the driver 5 with the help of a belt construction which is aimed to be placed round the driver's 5 chest, and in this case advantageously in a combination with a belt construction which is aimed to be placed over the driver's shoulders.

FIG. 2b shows an overview of a dosimeter 1 that is in close contact to the hipbone of a driver 5.

The measurements are typically performed under one entire working day, for example during a period of 8 hours. All data from vibration measurements is stored in the memory means 8 in order to make analyses if required. The calculated r.m.s. values and the VDV values are stored e.g. for one day. In this embodiment form the dosimeter calculates r.m.s. value for one working day. Data may also be stored for a longer period.

In this embodiment form the dosimeter 1 comprises a total temperature sensor 17. The aim with such a total temperature sensor 17 is to indicate body temperature or lack of body temperature and to make it possible to decide if the dosimeter is placed closely enough to the driver's 5 body. If the temperature from the total temperature sensor 17 falls below the preset parameter value, e.g. 30 Degrees Celsius, it typically means that the dosimeter is not applied on the driver 5. If the temperature from the total temperature sensor 17 falls below the preset parameter value it can alternatively signify that the dosimeter is not properly applied on the driver 5. The cause can be that the driver 5 has turned-on the dosimeter 1 without having it on/wearing it, alternatively has taken it off, forgetting to turn the dosimeter off. In all these cases the dosimeter 1 indicates the incorrect measurement value or excludes the measurements that are dated from those occasions when the temperature falls below the preset parameter value. In this embodiment with the total temperature sensor 17, the vibration data stored in the memory means 8 is related to the temperature measurements which indicate that the dosimeter was applied to the driver's body during the current measuring occasion.

In this embodiment the dosimeter comprises means to wirelessly communicate the mentioned vibration data. In this embodiment form the means is adapted to communicate the vibration data to a reader via RFID technique. In this embodiment the dosimeter comprises an aerial/antenna shaped as a coil with the tuning frequency that is in accordance with the reader's. An advantage with the RFID is that every dosimeter has unique identity to which the vibration data from a large number of working periods can be related to. In this embodiment form the dosimeter affects one of the applied reader's magnetic fields in order to transmit the vibration data.

In another embodiment the mentioned means to wirelessly communicate the vibration data is adjusted to communicate via a communication protocol which is generally used for the widespread cellular telephone units for communication via cellular phone network. An example of such communication protocol is GPRS and 3-G protocol.

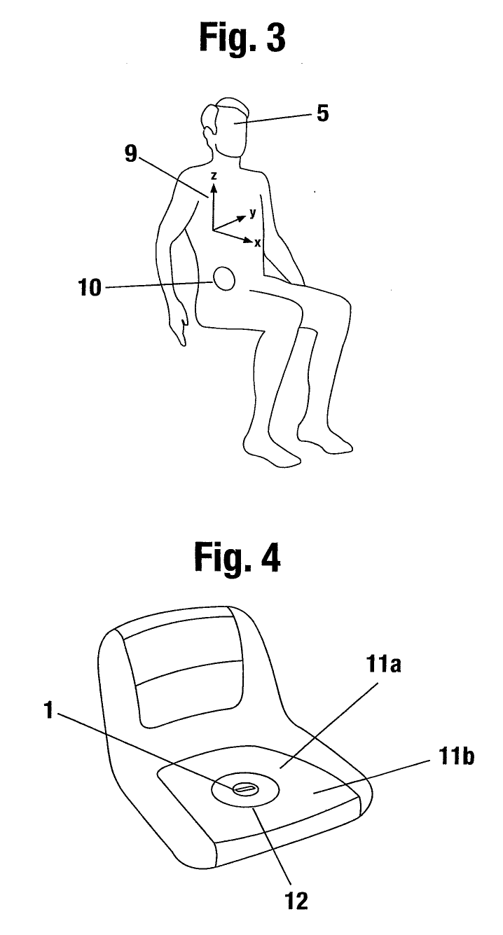

There are numbers of different types of vehicles or machines handled by the driver 5 which are viewed in FIG. 2a, FIG. 2b, FIG. 2c and FIG. 3. Examples of vehicles are: tractor, truck, front end loader or scooter. Examples of machines are: boat, drilling unit, scarifying machine, processor, soil-piling machine, asphalt paving machine and asphalt roller.

As already mentioned the vibration measurements with the dosimeter according to the invention do not require that the driver is seated. An example of it is while conveying a scooter when the driver 5 alternately sits, stands on both his feet or stands on one foot resting his other knee on the seat.

FIG. 3 shows a seated driver 5 where the measuring point 10 by his spine/back is indicated. It should be compared with the FIG. 4 which shows the measuring point 11a according to the previously known technique. In an alternative embodiment the dosimeter 1 comprises means to monitor the condition of the vehicle. Such condition monitoring may be based on evaluation of certain frequencies, such as below 150 Hz, enabling detection of changes in the vibration characteristics of the vehicle. Such changes may be detected by identifying certain peaks in the frequency plane, which may relate to a fault in a bearing. An increased risk for harshness of a vehicle may also be detected by monitoring the vibration level. The dosimeter may in some cases be located at a position in the vehicle other than attached to the driver.

FIG. 4 shows a measuring point 11a for vibration measurements according to the previously known measuring devices and methods which is on, by or under the seat 11b of the vehicle. As already mentioned in the section relating to state of the art, the well-known methods are based on the vibration measurements performed under simulated working conditions. As the FIG. 4 shows the vibration measurements are often performed according to the well-known methods on or under the seat 11b, not on the driver 5. However, the dosimeter 1 according to the invention can be also used for this type of customary measurements. In such case the dosimeter 1 is mounted in a measurement plate 12. One such measurement plate 12 comprises one substantial, partly soft construction element to imitate soft parts and suppression from the driver's 5 body. One such construction element has such characteristics that the measurement plate 12 is partly flexible. Such a measurement plate 12 comprises means of attachment of the dosimeter 1 to the plate. Examples of such attachment may comprise straps, a cavity or hole in the centre of the plate, a screw arrangement or any such combination.

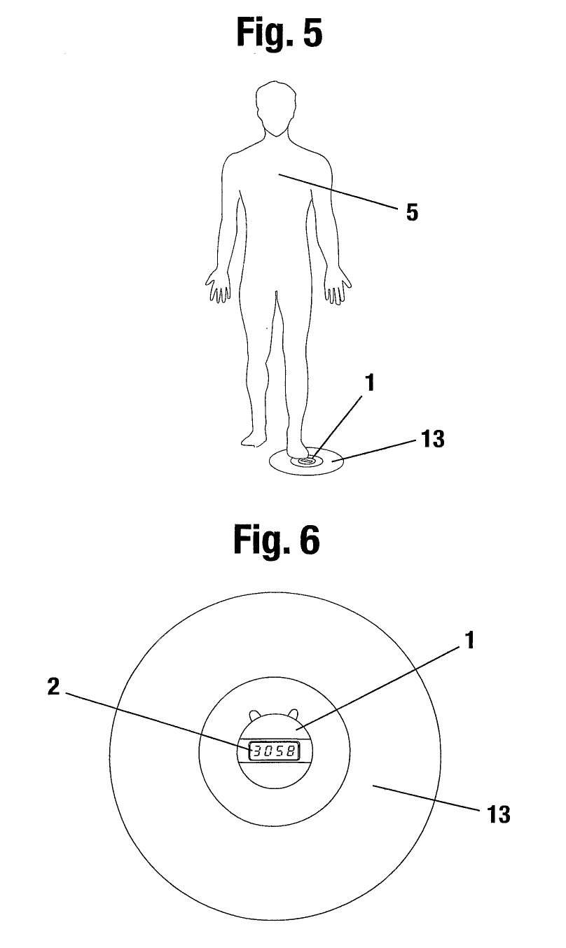

FIG. 5 shows a measuring for vibration measurements of vibrations transmitted to the person 14 via a floor. FIG. 5 indicates that the person 14 advantageously stands on the measurement plate 13 while the measuring is in progress. The floor is e.g. a floor in a structure with disturbing vibrations such as in a processing industry. Another example is a floor of a vessel. Further examples of structures with disturbing vibrations are: steelworks, sawmills or structures quite close to a railway or an underground. Guidelines for vibration measurements inside structures are provided e.g. in the international standard ISO 2631-2. Another example of guidelines for vibration measurements inside structures are described in the Swedish standard SS-ISO 8041/Amd.1.

FIG. 6 shows an alternative embodiment of the dosimeter 1 according to the invention. In this embodiment the dosimeter comprises an option in a form of a measurement plate 13. The aim of mounting the central unit of the dosimeter 1 in the measurement plate 13 is to allow vibration measurements inside structures without the person 14 standing on the dosimeter. In this case the measurement plate is an accessory to the dosimeter. Measurement plate 13 has its own considerable weight, e.g. 2.5 kg, which allows the dosimeter 1 in this embodiment to perform measurements described in the Swedish standard SS 4604861. A dosimeter with its central unit 1 mounted in the measurement plate follows the movements of the floor without affecting the measurement plate 13 by further weight or force.

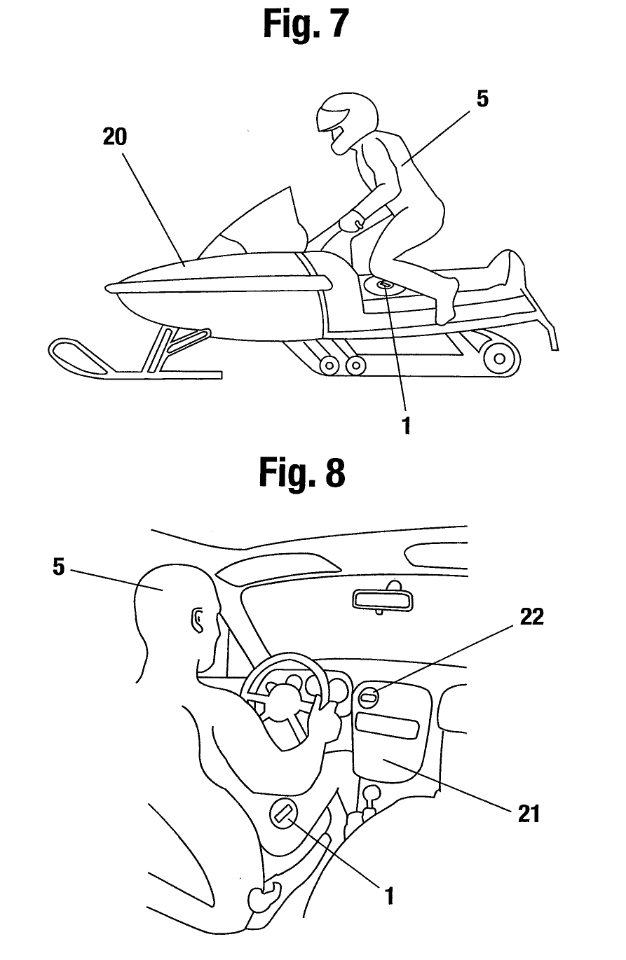

FIG. 7 shows an example of a vehicle 20 where a driver 5 is not typically seated during the whole working period. The vehicle in this example is a scooter/snowmobile 20. An alternative body part 1 that is appropriate for placing the dosimeter 1 in the vehicle in this case, which is a scooter/snowmobile is one of the driver's 5 knees.

A system according to the invention comprising a vibration indicator means 22 for presentation of the level of a recent vibration measurement and a level of accumulated vibration dose, measured by the vibration dosimeter 1. A recent vibration measurement may be presented on the vibration indicator by means of a display. The display may present vibration measurements with numbers, a color indication, such as green for a low level, yellow for a medium level and red for a high level. An audible alarm may be used to alert the driver if a total vibration dose has been exceeded. The vibration dosimeter 1 is during operation of the system attached to the driver 5. Alternatively the driver may sit on the dosimeter 1.

The invention can be embodied in multifarious ways. The embodiments above mentioned do not restrict the usage of the invention but it can be varied in multifarious ways within the frames of the patent claims below.

1. A dosimeter (1) for whole body vibration measurement comprising a vibration meter means, human body contact enabling elements (4), memory means (8) for storage of vibration data relating to a number of instances of measurements, a presentation means (2) where the result of vibration measurements are presented characterized in that, the contact enabling elements (4) are means of attachment of a belt intended to go around the upper part of the body of a driver;
the vibration meter means is a 3-axis accelerometer (16)
the dosimeter (1) comprises a computing means (7) to calculate an r.m.s. value for each instance of measurement of whole body vibration where input data to the computing means (7) is based on measurements of the 3-axis accelerometer (16), wherein the vibration data comprises the r.m.s. value related to each of the instances of measurements,
the computing means (7) is configured to calculate a r.m.s. value of a frequency range for each of the instances of measurements where the frequency range comprises frequencies mainly in the range of 0.5-80 Hz.

2. The dosimeter (1) according to claim 1 characterized in that the dosimeter (1) comprises a temperature meter (17) intended to detect body heat from the driver (5), wherein vibration data intended for storage in the memory means (8) is associated with temperature measurements, which indicates whether the dosimeter (1) was attached to the body of the driver (5) at each of the instances of measurements of vibration data.

3. The dosimeter (1) according to claim 2 characterized in that the dosimeter (1) comprises means for wireless communication of the vibration data.

4. The dosimeter (1) according to claim 2 characterized in that the dosimeter (1) is adapted to fit the centre of a measurement plate (12) , which measurement plate is an option to the dosimeter (1) and comprises an element which makes the measurement plate (12) at least partly flexible, wherein the dosimeter (1) is intended to measure vibrations at a driver's seat.

5. The dosimeter (1) according to claim 1 characterized in that the dosimeter (1) comprises a rotatable means, enabling the main body of the dosimeter (1) to be rotated, hence enabling at least two of the axis of the 3-axis accelerometer to be rotated, wherein of the at least two axis are possible to arrange in the main direction of the spine of a driver.

6. The dosimeter ( 1) according to claim 1 characterized in that the dosimeter (1) comprises means to calculate r.m.s. such as defined according to
$${a}_{w} = {[ \frac{1}{T} {\int }_{0}^{T} {a}_{w}^{2} ( t ) d t ]}^{\frac{1}{2}} ( {ms}^{- 2} )$$
where T is time for measurement and a_{w} is the weighted freguency acceleration.

7. A system for visualization of whole body vibration measurements of a driver (5) of a vehicle comprising:
a dosimeter (1), which comprises a 3-axis accelerometer (16), a computing means (7) to calculate an r.m.s. value for each instance of measurement of whole body vibration where input data to the computing means (7) is based on measurements of the 3-axis accelerometer (16), wherein the vibration data comprises the r.m.s. value related to each of the instances of measurements, the computing means (7) is configured to calculate an r.m.s. value of a frequency range for each of the instances of measurements where the frequency range comprises frequencies mainly in the range of 0.5-80 Hz; a vibration indicator (22) adapted to present the vibration measurements of the dosimeter (1) arranged at a position in front of the driver.

8. A system for visualization of whole body vibration measurements according to claim 7 characterized in that the dosimeter (1) comprises means to calculate r.m.s. such as defined according to
$${a}_{w} = {[ \frac{1}{T} {\int }_{0}^{T} {a}_{w}^{2} ( t ) d t ]}^{\frac{1}{2}} ( {ms}^{- 2} )$$
where T is time for measurement and aw is the weighted frequency acceleration.

9. The dosimeter (1) according to claim 3 characterized in that the dosimeter (1) is adapted to fit the centre of a measurement plate (12), which measurement plate is an option to the dosimeter (1) and comprises an element which makes the measurement plate (12) at least partly flexible, wherein the dosimeter (1) is intended to measure vibrations at a driver's seat.

10. The dosimeter (1) according to claim 2 characterized in that the dosimeter (1) comprises a rotatable means, enabling the main body of the dosimeter (1) to be rotated, hence enabling at least two of the axis of the 3-axis accelerometer to be rotated, wherein of the at least two axis are possible to arrange in the main direction of the spine of a driver.

11. The dosimeter (1) according to claim 3 characterized in that the dosimeter (1) comprises a rotatable means, enabling the main body of the dosimeter (1) to be rotated, hence enabling at least two of the axis of the 3-axis accelerometer to be rotated, wherein of the at least two axis are possible to arrange in the main direction of the spine of a driver.

12. The dosimeter (1) according to claim 4 characterized in that the dosimeter (1) comprises a rotatable means, enabling the main body of the dosimeter (1) to be rotated, hence enabling at least two of the axis of the 3-axis accelerometer to be rotated, wherein of the at least two axis are possible to arrange in the main direction of the spine of a driver.
